(19) United States
(12) Patent Application Publication
(10) Pub. No.: US 2026/0280771 A1
(43) Pub. Date: Sep. 17, 2026

(54) HIGHLY RELIABLE TRANSMISSION FOR MLO BA PROCEDURE

(71) Applicant: HEWLETT PACKARD ENTERPRISE DEVELOPMENT LP, Spring, TX (US)

(72) Inventors: Xuguang Jia, Beijing (CN); Yongchang Guo, Beijing (CN); Xiaoyang Fu, Beijing (CN)

(21) Appl. No.: 19/076,528

(22) Filed: Mar. 11, 2025

(51) Int. Cl. H04L 1/1812; H04L 5/00; H04W 48/20

(52) U.S. Cl. CPC H04L 1/1812; H04L 5/0053; H04W 48/20

(57) ABSTRACT

A method for data transmission for block acknowledgment. The method comprises determining that a number of frames retransmitted on an uplink from a station to a first access point (AP) meets a predetermined condition. The method further comprises selecting a second AP to assist the station in transmitting frames to the first AP. The method further comprises receiving a second frame from the second AP, where the second frame is a duplicated frame of a first frame, and the first frame is transmitted by the station to the first AP through a block. The method further comprises updating acknowledgment information corresponding to the first frame, where the acknowledgment information indicates received frames and missing frames in the block. In addition, the method further comprises transmitting the acknowledgment information to the station through the first AP.

### BACKGROUND

Block Acknowledgment (BA) is a mechanism in wireless communications used to improve efficiency and reliability during data transmissions. Instead of sending an individual acknowledgment (ACK) for each transmitted packet, which increases overhead and latency, the BA procedure allows the receiver to send a single acknowledgment for multiple transmitted packets at once. For example, the receiver may be an access point (AP) or a station.

Multi-link operation (MLO) is a feature introduced in Wi-Fi 7. MLO allows a non-AP multi-link device (MLD) to discover, authenticate, associate, and establish multiple links with an AP MLD. Once the MLD setup procedure is complete, each link facilitates channel access and frame exchanges between the non-AP MLD and the AP MLD.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example implementations of the present disclosure may be implemented;

FIG. 2 shows a flow chart illustrating a method of data transmission for BA according to the implementations of the present disclosure;

FIG. 3 shows a flow chart illustrating an example process of selecting an AP to assist in data transmission according to the implementations of the present disclosure;

FIG. 4 shows a schematic diagram illustrating an example of transmitting frames from a station to an AP through an uplink according to the implementations of the present disclosure;

FIG. 5 shows a schematic diagram illustrating an example of updating a BA score board maintained at the UMLD UMAC according to the implementations of the present disclosure;

FIG. 6 shows a schematic diagram illustrating an example of transmitting frames from an AP to a station through a downlink according to the implementations of the present disclosure;

FIG. 7 shows a diagram illustrating an example network device according to the implementations of the present disclosure; and

FIG. 8 shows a diagram illustrating an example AP according to the implementations of the present disclosure.

### DETAILED DESCRIPTION

BA is a feature in Wi-Fi that allows for the acknowledgment of multiple data frames at once. Instead of sending an acknowledgment for each individual frame, the receiver sends a single acknowledgment for a block of frames. For example, in some traditional schemes, a station is transmitting a series of data frames to an AP. These frames are aggregated together into a single block for efficient acknowledgment. Then, the block is transmitted to the AP. Upon receiving the block, the AP does not send individual acknowledgments for frames in the block. Instead, the AP maintains acknowledgment information for the entire block of frames. This acknowledgment information may be stored as a scoreboard or a bitmap, which tracks the reception status of each frame in the block. The acknowledgment information indicates which frames are successfully received and which frames are missing or require retransmission. The AP transmits the acknowledgment information (e.g., typically in the form of a BA frame) back to the station. Upon receiving the BA frame from the AP, the station checks the acknowledgment information to identify the frames that are not successfully received. In the next transmission block, the station may aggregate these frames to be retransmitted and new frames into a new block, and transmit the new block to the AP.

However, the traditional BA process suffers from several significant defects due to various factors that affect wireless transmission, leading to frequent retransmissions, data loss, and transmission delays. For example, traditional retransmission models primarily focus on a single link or the multi-link scenario of a single AP device. These models typically require multiple retransmission attempts on the previously failed link or band, thereby increasing the number of retransmitted frames. The need for frequent retransmissions wastes valuable air time and wireless resources. The increased retransmissions may lead to increased network congestion and interference, poor air quality, and further delays. Therefore, the overall network throughput and efficiency may be reduced.

In addition, MLDs experience varying power coverage across different frequency bands, making it difficult for hidden station MLD nodes to effectively complete link selection and roaming decisions. As a result, these nodes are more likely to encounter unstable connections or data loss on the original active links.

The present invention provides a scheme of frame transmission for the BA process. In the scheme of the present invention, a first AP and a station are MLDs. The first AP may receive a block of frames from the station through an uplink. If the first AP fails to receive some frames in the block, the station may retransmit these frames in a next block. A network device (e.g., an AP, a controller, or a server on the cloud) may determine that the performance of the uplink is low by determining that a number of frames retransmitted on the uplink meets a predetermined condition (e.g., the number of retransmitted frames is greater than a threshold). Then, the network device may select, based on a predetermined strategy, a second AP being able to receive data transmitted to assist the station in transmitting frames to the first AP.

When the station transmits a first frame to the first AP, the second AP may capture the first frame and transmit a duplicated frame (e.g., a second frame) to the network device. Therefore, the network device may determine two outcomes: the first outcome indicates whether the first frame is received by the first AP, and the second outcome indicates whether the second frame is received by the network device itself. The network device may maintain scoreboards for BA blocks. Each of the scoreboards indicates the received frames and missing frames within a corresponding block. The network device may update a respective scoreboard based on the two reception results. For example, a bit corresponding to the first frame in the scoreboard may be set if either the first frame or the second frame is received by the first AP or the network device. The network device may then transmit the updated scoreboard to the station through the first AP.

In this way, the network device may transmit the second frame to the first AP when the first AP fails to receive the first frame. The scoreboard transmitted to the station indicates that the first frame is received by the first AP. Therefore, the number of retransmitted frames from the station to the first AP can be reduced, and the stability of the network can be improved.

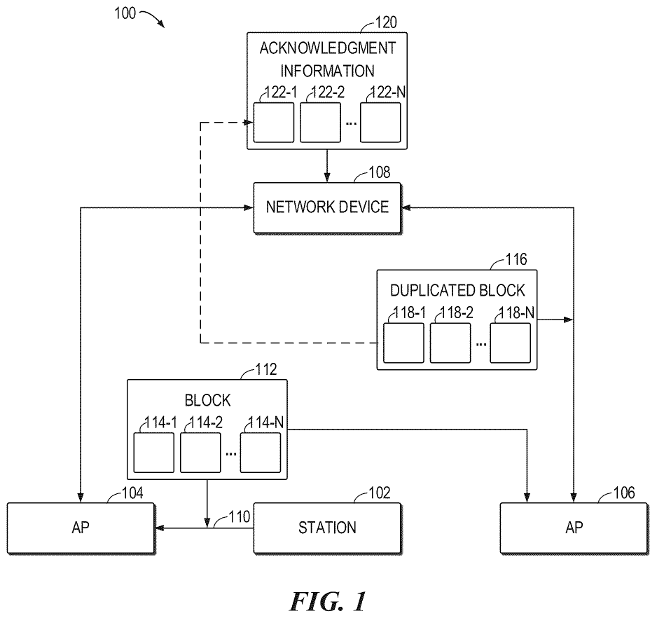

FIG. 1 illustrates an example environment 100 in which example implementations of the present disclosure may be implemented. As shown in FIG. 1, the environment 100 includes a station 102, an AP 104, an AP 106, and a network device 108. The station 102 is a device that communicates within a Wi-Fi network. For example, the station 102 may be a laptop, a smartphone, a tablet, or other networked equipment. The station 102 may initiate communication and exchange data frames with APs or other network devices. In the environment 100, the station 102 may be a station MLD that can operate on multiple wireless links, usually across different frequency bands (e.g., 2.4 GHz, 5 GHz, and 6 GHz) in parallel. Unlike traditional single-link stations, a station MLD can transmit and receive data across these multiple links simultaneously, significantly improving overall network performance.

The AP 104 and the AP 106 are devices that provide wireless connectivity to a network. The AP 104 and the AP 106 may be connected to a wired router, switch, or hub, allowing wireless devices to access network resources without physical cables. The AP 104 and the AP 106 may transmit and receive data frames to communicate with stations (e.g., the station 102) within their coverage area. In the environment 100, the AP 104 may be an AP MLD, and the AP 106 may be either an MLD or a non-MLD. An AP MLD can operate on multiple frequency bands simultaneously. For example, the AP MLD can support 2.4 GHz, 5 GHz, and 6 GHz bands. This allows the AP MLD to manage traffic across multiple links and adapt to different network conditions, ensuring better performance and coverage. By utilizing multiple links, the AP MLD can handle more data at once, providing higher throughput for stations connected to the network. The multi-links can increase the overall capacity of the network by reducing congestion on any single link, particularly in high-density environments such as office buildings, stadiums, or public venues. Furthermore, the AP MLD can enhance reliability by providing multiple paths for communication. If one link encounters interference or degradation, the AP MLD can use another link to ensure continuous and stable connectivity.

In some implementations, the network device 108 may be a controller. The controller may manage and orchestrate the operations of multiple APs within a network. This setup is often used in enterprise and large-scale wireless networks to provide centralized control, simplify management, and ensure efficient coordination between various APs. The controller can be either a physical device or a virtual machine. In some implementations, the network device 108 may be a cloud server providing services to manage and orchestrate the operations of multiple APs. This setup eliminates the need for on-site management and enables centralized control, making it ideal for large-scale, distributed networks, such as networks in enterprises, campuses, and public spaces. In some implementations, the network device 108 may be the AP 104 itself or a part of the AP 104.

In the environment 100, an uplink 110 is a link from the station 102 and the AP 104. The uplink 110 may operate at a specified band (e.g., 2.4 GHz, 5 GHz, or 6 GHz). The station 102 may transmit frames to the AP 104 through the uplink 110 using the BA mechanism. For example, the station 102 may transmit a block of frames at once to the AP 104. The AP 104 may acknowledge the block of frames using a single BA frame. The BA frame may contain a score board with multiple bits. Each bit of the score board may indicate the status (e.g., received or missing) of a frame in the block.

In the environment 100, the AP 104 may communicate with the network device 108. The network device 108 may determine whether a number of frames retransmitted on the uplink 110 from the station 102 to the AP 104 meets a predetermined condition. In some implementations, the AP 104 may determine the number of missing frames based on the acknowledgment information (e.g., the score board at the AP 104). The network device 108 may obtain the number of missing frames from the AP 104 as the number of frames retransmitted on the uplink 110. The network device 108 may determine that the number of frames retransmitted on the uplink 110 meets the predetermined condition by determining that the number of frames retransmitted on the uplink 110 is greater than a predetermined retransmission threshold. In some implementations, The AP 104 may determine that the number of frames retransmitted on the uplink 110 is greater than a predetermined retransmission threshold. Then, the AP 104 may send a message or a request indicating a retransmission issue to the network device 108. The network device 108 may determine that the number of frames retransmitted on the uplink 110 meets the predetermined condition by receiving this message or request.

In the environment 100, upon determining that the number of frames retransmitted on the uplink 110 is greater than the predetermined retransmission threshold, the network device 108 may select the AP 106 (also referred to as a virtual AP) to assist the station 102 in transmitting frames to the AP 104. The AP 106 may be selected from neighbor APs of the AP 104 based on network conditions of the neighbor APs, and the AP 106 is able to receive data transmitted by the station 102. Multiple factors that affect the performance and the reliability of the links between the APs and the station 102 may be considered. For example, these factors may include one or more of the capabilities of the links between the station 102 and the APs (e.g., Media Access Control/Physical Layer capabilities and bandwidth), the air interface quality (e.g., channel utilization, noise figure (NF), received signal strength indicator (RSSI), etc.), the idle service time of the APs (e.g., time division duplex (TDD) concept and target wake time (TWT) service periods (SPs)), the latency of the links, the throughput of the links, and the distance from the station 102 to the APs. Once the AP 106 is selected, the network device 108 may configure the AP 106 to assist the station 102 in transmitting frames to the AP 104.

In the environment 100, after the AP 106 is configured to assist the station 102 in transmitting frames to the AP 104, the station 102 may transmit a block 112 to the AP 104. The block 112 may include frames 114-1, 114-2, . . . , and 114-N (also collectively referred to as frames 114). The AP 106 may capture the block 112 and generate a duplicate block 116 corresponding to the block 112. The duplicated block 116 may include duplicated frames corresponding to the frames 114. As shown in FIG. 1, the duplicated block 116 may include duplicated frames 118-1, 118-2, . . . , and 118-N (also collectively referred to as duplicated frames 118), where the duplicated frame 118-1 corresponds to the frame 114-1, the duplicated frame 118-2 corresponds to the frame 114-2, . . . , and the duplicated frame 118-N corresponds to the frame 114-N. Then, the AP 106 may transmit the duplicated block 116 to the network device 108. The network device 108 may receive the duplicated frames 118 from the AP 106.

In the environment 100, the network device 108 may maintain acknowledgment information 120 for the block 112. The acknowledgment information 120 may include reception statuses 122-1, 122-2, . . . , and 122-N (also collectively referred to as reception statuses 122) for the frames 114. The reception status 122 may indicate whether the frames 114 are received or missing. In the environment 100, the acknowledgment information 120 may be shared by the APs 104 and 106. For example, if the frame 114-1 is received by the AP 104 or the duplicated frame 118-1 is received by the network device 108, the reception status 122-1 may be updated to ‘received’.

In the environment 100, the network device 108 may transmit acknowledgment information 120 to the AP 104. If the AP 104 fails to receive the frame 114-1, the network device 108 may also transmit the duplicated frame 118-1 of the frame 114-1 to the AP 104. Then, the AP 104 may transmit the acknowledgment information 120 to the station 102. In the acknowledgment information 120, the reception status 122-1 is ‘received’. Therefore, the station 102 may determine that the frame 114-1 is received by the AP 104. Thus, the frame 114-1 will not be retransmitted in the next block.

In this way, the network device 108 may transmit the duplicated frame 118-1 to the AP 104 when the AP 104 fails to receive the frame 114-1. The acknowledgment information 120 transmitted to the station 102 indicates that the frame 114-1 is received by the AP 104. Therefore, the number of retransmitted frames from the station 102 to the AP 104 can be reduced, and the stability of the network can be improved.

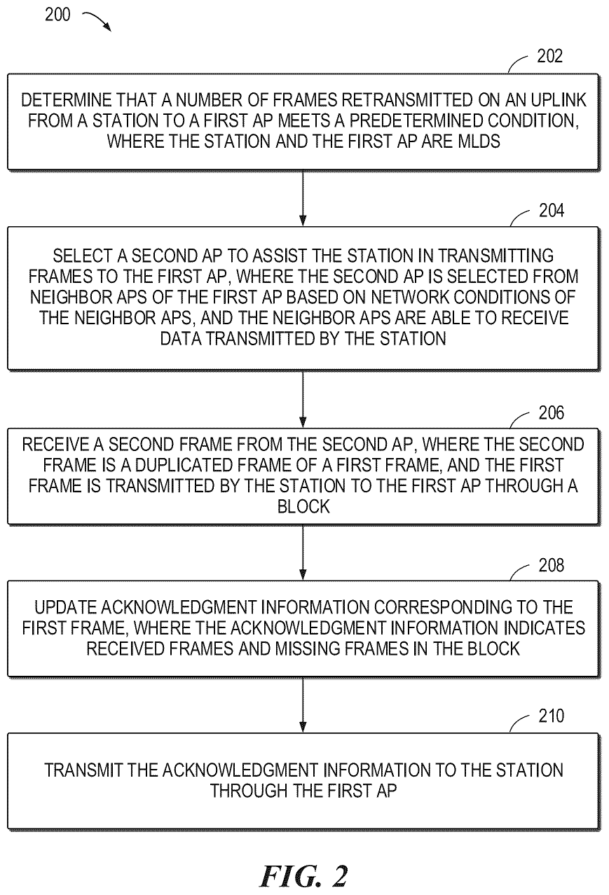

FIG. 2 shows a flow chart illustrating a method 200 of data transmission for BA according to the implementations of the present disclosure. The method 200 may be implemented by a network device, for example, the network device 108 in FIG. 1. The network device may be a controller, a server, or an AP. As shown in FIG. 2, at block 202, the network device may determine that a number of frames retransmitted on an uplink from a station to a first AP meets a predetermined condition, where the station and the first AP are MLDs. For example, in the environment 100, as shown in FIG. 1, the network device 108 may determine whether a number of frames retransmitted on the uplink 110 from the station 102 to the AP 104 meets a predetermined condition. The network device 108 may determine that the number of frames retransmitted on the uplink 110 meets the predetermined condition by determining that the number of frames retransmitted on the uplink 110 is greater than a predetermined retransmission threshold. In some implementations, The AP 104 may determine that the number of frames retransmitted on the uplink 110 is greater than a predetermined retransmission threshold. Then, the AP 104 may send a message or a request indicating a retransmission issue to the network device 108. The network device 108 may determine that the number of frames retransmitted on the uplink 110 meets the predetermined condition by receiving this message or request.

At block 204, the network device may select a second AP to assist the station in transmitting frames to the first AP, where the second AP is selected from neighbor APs of the first AP based on network conditions of the neighbor APs, and the neighbor APs are able to receive data transmitted by the station. For example, in the environment 100, as shown in FIG. 1, the network device 108 may select the AP 106 to assist the station 102 in transmitting frames to the AP 104. The AP 106 may be selected from neighbor APs of the AP 104 based on network conditions of the neighbor APs according to a predetermined strategy. Furthermore, the AP 106 is able to receive data transmitted by the station 102.

At block 206, the network device may receive a second frame from the second AP, where the second frame is a duplicated frame of a first frame, and the first frame is transmitted by the station to the first AP through a block. For example, in the environment 100, as shown in FIG. 1, the network device 108 may receive the duplicated block 116 from the AP 106. The duplicated block 116 may include duplicated frames 118 of the frames 114. The AP 106 may capture the block 112 and generate the duplicated block 116 corresponding to the block 112 when the station 102 transmits the block 112 to the AP 104.

At block 208, the network device may update acknowledgment information corresponding to the first frame, where the acknowledgment information indicates received frames and missing frames in the block. For example, in the environment 100, as shown in FIG. 1, the network device 108 may maintain the acknowledgment information 120 for the block 112. The reception status 122 in the acknowledgement information 120 may indicate whether the frames 114 are received. After receiving the duplicated frame 118-1, the network device 108 may set the reception status 122-1 corresponding to the frame 114-1 to ‘received’, even if the AP 104 fails to receive the frame 114-1.

At block 210, the network device may transmit the acknowledgment information to the station through the first AP. For example, in the environment 100, as shown in FIG. 1, the network device 108 may transmit the acknowledgment information 120 to the AP 104. If the AP 104 fails to receive the frame 114-1, the network device 108 may also transmit the duplicated frame 118-1 of the frame 114-1 to the AP 104. Then, the AP 104 may transmit the acknowledgment information 120 to the station 102. In the acknowledgment information 120, the reception status 122-1 is ‘received’. Therefore, the station 102 knows the frame 114-1 is received by the AP 104. Thus, the frame 114-1 will not be retransmitted in a next block.

In this way, the network device may transmit the second frame to the first AP when the first AP fails to receive the first frame. The acknowledgment information transmitted to the station indicates that the first frame is received by the first AP. Therefore, the number of retransmitted frames from the station to the first AP can be reduced, and the stability of the network can be improved.

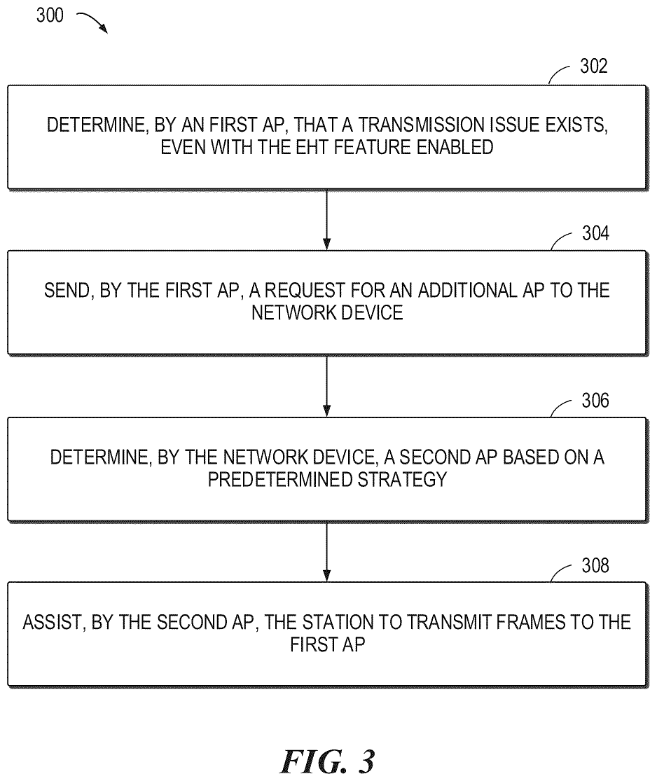

FIG. 3 shows a flow chart illustrating an example process 300 of selecting an AP to assist in data transmission according to the implementations of the present disclosure. As shown in FIG. 3, at block 302, a first AP (e.g., the AP 104 in FIG. 1) may determine that a transmission issue exits, even with the extremely high throughput (EHT) feature being enabled. The EHT feature is designed to improve wireless network performance by supporting higher data rates, more efficient spectrum usage, and reduced latency. For example, the EHT feature supports faster data transmission speeds, thereby enabling more robust and high-speed wireless communication, especially in environments with heavy traffic. Furthermore, the EHT feature introduces the use of 320 MHz channels, significantly wider than those used in previous Wi-Fi standards, which allows for more data to be transmitted simultaneously. In addition, the EHT feature leverages higher-order modulation to pack more data into each symbol, thereby improving throughput, especially in high-signal environments.

When a transmission issue is detected, the network device (e.g., the network device 108 in FIG. 1) may enable the EHT feature to resolve the issue. Then, the first AP may determine whether the issue still exists. For example, the first AP may determine a number of missing frames based on acknowledgment information maintained by itself. If the number of missing frames is greater than a predetermined threshold, the original may determine that the issue still exists even with the EHT feature enabled. Then, the process 300 may proceed to block 304.

At block 304, the first AP may send a request for an additional AP to the network device. The request may indicate that there is a transmission issue on the uplink between the station and the first AP. After receiving the request from the first AP, the network device may determine that the number of retransmitted frames on the uplink between station and the first AP meets the predetermined condition.

At block 306, the network device may determine a second AP based on a predetermined strategy. The network device may determine the neighbor APs of the first AP, and collect real-time data associated with these neighbor APs. Therefore, the network device may select an AP to assist the station in data transmission based on the collected data.

In some implementations, the neighbor APs of the first AP may include a second AP and a third AP. If the network device determines that the second AP is an MLD and the third AP is a non-MLD, it may select the second AP instead of the third AP to assist the station in transmitting the frames to the first AP. The second AP can communicate over multiple frequency bands (e.g., 2.4 GHz, 5 GHz, and 6 GHz) simultaneously. This increases the reliability of the communication link, thereby reducing the chances of frame loss due to interference or congestion on a single band. By selecting the second AP, the network device can leverage these multiple links to improve the overall link reliability and resilience. Furthermore, MLDs can optimize communication by intelligently managing multiple links to prevent congestion and reduce the time spent on retransmissions. This can result in better use of available wireless resources. By selecting the second AP, the network device can improve overall system efficiency, thereby reducing network congestion and improving the overall user experience.

In some implementations, in a case that both the second AP and the third AP are MLDs, if the network device determines that a number of links of the second AP is greater than a number of links of the third AP, it may select the second AP instead of the third AP to assist the station in transmitting the frames to the first AP. For example, the second AP may have three radios operating on 2.4 GHz, 5 GHz, and 6 GHz. The third AP may have two radios operating on 2.4 GHz and 5 GHz. Therefore, the network device may select the second AP because the second AP may transmit data on more links than the third AP. With more links available, the second AP offers better redundancy and reliability. If one radio or frequency band faces interference or congestion, the other links can still be used to maintain the communication link. This increases the likelihood of successful data transmission without interruptions. By selecting the second AP, the network device can reduce the chance of communication failure, thereby leading to more stable connections.

In some implementations, the network device may determine a load of the second AP. If the network device determines that the load of the second AP is less than a predetermined load threshold, it may select the second AP to assist the station in transmitting the frames to the first AP. By selecting the second AP only when its load is below a predetermined threshold, the network device ensures that the AP is not overloaded. This prevents resource contention and ensures that the second AP can handle additional traffic without negatively impacting its performance or the performance of other devices connected to it. Furthermore, by selecting the second AP only under favorable conditions, the network device helps maintain the stability of the overall network, thereby avoiding situations where overloaded APs cause disruptions in the service.

In some implementations, the network device may determine a first score indicating performance of the first AP based on a channel utility and a client number of the first AP. Furthermore, the network may determine a second score indicating performance of the second AP based on a channel utility and a client number of the second AP. If the network device determines that the second score is greater than the first score, it may select the second AP to assist the station in transmitting the frames to the first AP.

The channel utility may measure how effectively a particular AP is utilizing its allocated wireless channel. A high channel utility may indicate that the AP is being used efficiently, while a low utility may indicate underuse or congestion. In some implementations, the channel utility may be determined based on at least one of the channel bandwidth usage, the channel interference levels, the channel access delay, or the signal-to-noise ratio (SNR). The client number refers to the number of stations that are connected to the AP. A higher number of connected clients generally means that the AP is handling a larger volume of traffic. However, if the client number is too high, it may indicate potential congestion, which could lead to degraded performance for both the AP and its clients. Based on these two metrics, the network device may calculate the performance scores for the first AP and the second AP. In this way, the network device can balance the traffic load between APs by directing traffic to the second AP with better performance. This reduces the risk of congestion on any single AP and improves overall network performance. Furthermore, selecting the second AP based on the performance scores can ensure that the network avoids placing too many clients or too much traffic on any single AP, which could lead to congestion and performance degradation.

At block 308, the second AP may assist the station in transmitting frames to the first AP. As described above, when the station is transmitting frames to the first AP, the second AP may capture the frames and transmit duplicated frames to the network device. The network device may update the acknowledgment information based on the received duplicated frames. In this way, the reliability of the data transmission can be improved. Furthermore, the number of retransmitted frames can be reduced. Therefore, the network resources can be saved, and the performance of the network can be improved.

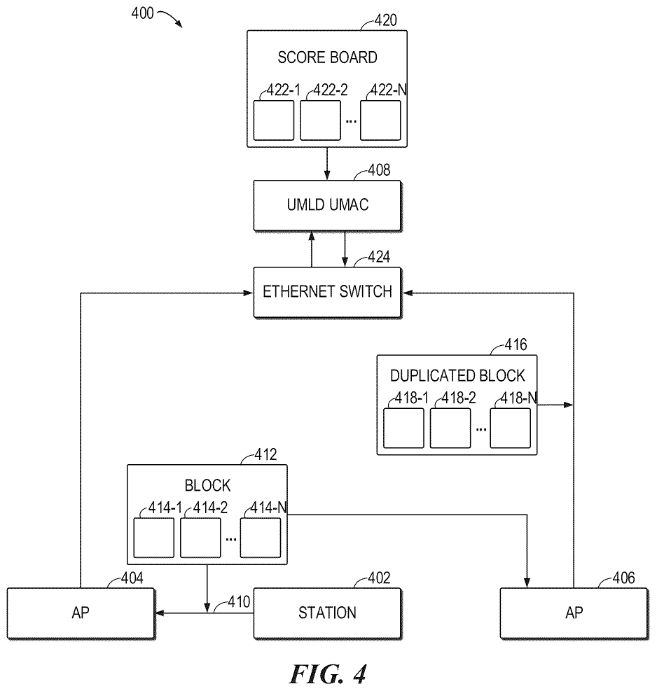

FIG. 4 shows a schematic diagram illustrating an example 400 of transmitting frames from a station to an AP through an uplink according to the implementations of the present disclosure. As shown in FIG. 4, the example 400 comprises a station 402, an AP 404, an AP 406, a unified MLD (UMLD) universal MAC (UMAC), and an Ethernet switch 424.

Traditional MAC mechanisms are typically designed to handle communication of a single link. The UMLD UMAC 408, on the other hand, may provide a single unified MAC protocol that supports multi-link operations across different frequency bands and APs. This approach can reduce complexity and improve efficiency when managing multiple links in environments with MLDs. The UMLD UMAC 408 may provide seamless and efficient coordination across multiple APs and links, enabling the use of multiple radios and channels simultaneously, while maintaining overall network stability and maximizing resource usage.

In the example 400, the station 402, the AP 404, and the AP 406 may be MLDs. The UMLD UMAC 408 allows the station 402, the AP 404 and the AP 406 to collaborate effectively across multiple links. It manages data transmission across different frequency bands and radios by coordinating the flow of traffic between multiple links on these MLDs. For example, the station 402 may have access to the APs 404 and 406 or different radio channels, and the UMLD UMAC 408 may help schedule and manage this communication efficiently. Furthermore, in a typical MLD scenario, each link might have its own MAC layer management. The UMLD UMAC 408 may integrate these individual MACs into one cohesive system, thereby simplifying the process of managing multiple links. This ensures that the station 402, the AP 404 and the AP 406 can work together across multiple links. In the example 400, the ULMD UMAC 408 may be implemented on a controller. In some other examples, the ULMD UMAC 408 may be implemented on a server.

In the example 400, the AP 404, the AP 406, and the UMLD UMAC 408 may be connected through the Ethernet switch 424 to communicate over Ethernet. In this way, Ethernet connections may avoid the wireless interference issues that Wi-Fi networks face (e.g., signal attenuation, channel congestion, etc.), thereby ensuring stable data transmission. By using wired connections, transmission errors caused by weak signals, noise, and electromagnetic interference among the AP 404, the AP 406, and the UMLD UMAC 408 can be reduced. In addition, because Ethernet is more stable than wireless connections, the data loss caused by poor coverage or interference can be reduced.

In the example 400, the station 402 may transmit frames to the AP 404 through an uplink 410 using the BA mechanism. The station 402 may transmit a block of frames to the AP 404. The AP 404 may acknowledge the block of frames using a single BA frame. The UMLD UMAC 408 may determine that there is a transmission issue on the uplink 410. For example, the UMLD UMAC 408 may determine that the number of frames retransmitted on the uplink 410 meets a predetermined condition. The UMLD UMAC 408 may also detect the transmission issue on the uplink 410 by monitoring specific behaviors that indicate problems in the wireless network. For example, when the station 402 starts sending a large number of Request to Send (RTS) frames, it may be attempting to compete for the air resources more frequently than usual. Therefore, the UMLD UMAC 408 may determine that there is a transmission issue on the uplink 410 by determining that the number of RTS frames sent by the station 402 is greater than a predetermined threshold. For another example, if the transmission rate drops significantly from a higher speed to a lower speed, this is a sign that the link quality has degraded. A sudden change in the transmission rate may indicate that the uplink 410 is experiencing problems. Therefore, the UMLD UMAC 408 may determine that there is a transmission issue on the uplink 410 by determining that the change in the transmission rate is greater than a predetermined threshold.

After detecting the transmission issue on the uplink 410, the UMLD UMAC 408 may synchronize with the AP 406 to assign a dedicated link or band (also referred to as a virtual link) to monitor the uplink 410. In the example 400, the UMLD UMAC 408 may set specific frame pattern rules to filter the frames captured by the AP 406, and synchronize these rules to the AP 406. For example, the AP 406 may monitor the frames transmitted by the station 402 on the uplink 410. The AP 406 may filter the frames destined for the AP 404 that have a specific TID, a specific MAC address, or a specific frame type. Therefore, the AP 406 may duplicate these filtered frames and transmit the duplicated frames to the UMLD UMAC 408 through the Ethernet switch 424. In this way, the number of frames to be duplicated and transmitted can be reduced. Thus, the latency of the network can be reduced.

In the example 400, after the AP 406 (or a link of the AP 406) is configured to assist the station 402 in transmission frames to the AP 404, the station 402 may transmit a block 412 to the AP 404. The block 412 may include frames 414-1, 414-2, . . . , and 414-N (also collectively referred to as frames 414). The AP 406 may capture the block 412 based on its destination and the specified rules, and generate a duplicated block 416 corresponding to the block 412. The duplicated block 416 may include duplicated frames corresponding to the frames 414. For example, the station 402 may transmit a frame (e.g., the frame 414-1) to the AP 404, and the frame is assigned a specific TID (e.g., TID 5) to indicate the traffic class. The AP 406, upon receiving this frame, may apply a filtering rule based on the TID value. If the TID of the frame matches TID 5, the AP 406 can identify this as a high-priority frame for real-time services (e.g., video streaming). In this case, the AP 406 may filter out all other frames but will duplicate and transmit only the frame with TID 5 to the UMLD UMAC 408 through the Ethernet switch 424. In this way, the AP 406 ensures that only high-priority frames with TID 5 are duplicated and transmitted to the UMLD UMAC 408 for further processing. As a result, the number of duplicated frames is minimized, thereby reducing network latency and improving efficiency.

In the example 400, the duplicated block 416 may include duplicated frames 418-1, 418-2, . . . , and 418-N (also collectively referred to as duplicated frames 418), where the duplicated frame 418-1 corresponds to the frame 414-1, the duplicated frame 418-2 corresponds to the frame 414-2, . . . , and the duplicated frame 418-N corresponds to the frame 414-N. Then, the AP 406 may transmit the duplicated block 416 to the UMLD UMAC 408.

The UMLD UMAC 408 may maintain a score board 420 for the block 412. The score board 420 may include reception statuses 422-1, 422-2, . . . , and 422-N (also collectively referred to as reception statuses 422) for the frames 414. The reception statuses 422 may indicate whether the frames 414 are received or missing. If the frame 414-1 is received by the AP 404 or the duplicated frame 418-1 is received by the UMLD UMAC 408, the reception status 422-1 may be updated to ‘received’.

In the example 400, the UMLD UMAC 408 may transmit the score board 420 to the AP 404. If the AP 404 fails to receive the frame 414-1, the UMLD UMAC 408 may also transmit the duplicated frame 418-1 of the frame 414-1 to the AP 404 through the Ethernet switch 424. Then, the AP 404 may transmit the score board 420 to the station 402. In the score board 420, the reception status 422-1 is ‘received’. Therefore, the station 402 may determine that the frame 414-1 is received by the AP 404. Thus, the frame 414-1 will not be retransmitted in the next block. In this way, the number of retransmitted frames from the station 402 to the AP 404 can be reduced, and the stability of the network can be improved.

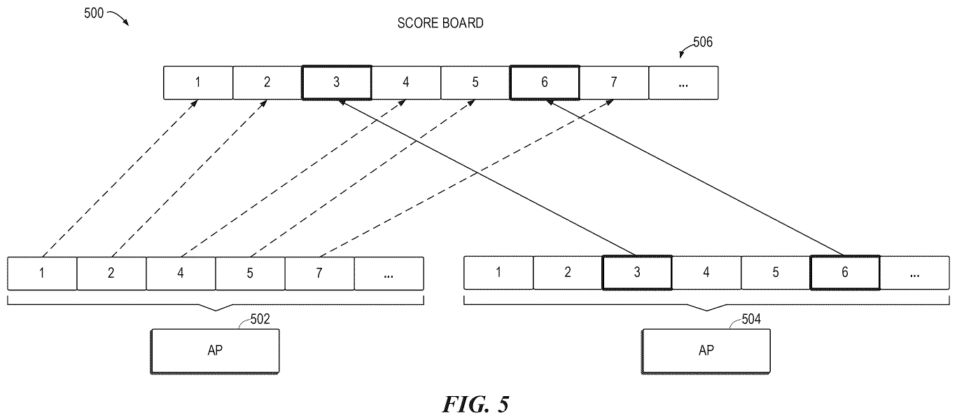

FIG. 5 shows a schematic diagram illustrating an example 500 of updating a BA score board maintained at the UMLD UMAC according to the implementations of the present disclosure. As shown in FIG. 5, the example 500 includes an AP 502 (e.g., the AP 404 in FIG. 4), an AP 504 (e.g., the AP 406 in FIG. 4), and a score board 506 (e.g., the score board 420 in FIG. 4) maintained at a UMLD UMAC (e.g. the UMLD UMAC 408 in FIG. 4). The AP 504 is selected by the UMLD UMAC to assist a station in transmitting frames to the AP 502.

In the example 500, the station may transmit frames 1, 2, 3, 4, 5, 6, 7 to the AP 502. However, as shown in FIG. 5, frames 1, 2, 4, 5, and 7 are received by the AP 502, while the frames 3 and 6 are missing during transmission. The AP 502 may report identifications of the received frames and missing frames to the UMLD UMAC. The UMLD UMAC may update fields 1, 2, 4, 5, and 7 in the score board 506 to ‘received’, where the fields 1 to 7 represent the reception statuses of the frames 1 to 7.

In addition, the AP 504 may capture the frames transmitted from the station to the AP 502 and transmit duplicated frames to the UMLD UMAC. As shown in FIG. 5, duplicated frames 1, 2, 3, 4, 5, and 6 are received by the UMLD UMAC, while the frame 7 is missing during transmission. Upon receiving the duplicated frames 1, 2, 3, 4, 5, and 6, the UMLD UMAC may update the fields 3 and 6, which indicate the frames 3 and 6 are missing, to ‘received’. Therefore, all the fields 1 to 7 in the score board 506 will be set to ‘received’. The UMLD UMAC may then transmit the duplicated frames 3 and 6 to the AP 502 along with the updated score board 506. The AP 502 may acknowledge all the frames 1 to 7 by transmitting a BA frame containing the score board 506 to the station. In this way, the frames 3 and 6 can be acknowledged by the AP 502. Thus, the reliability of the network can be improved.

During the process of transmitting frames from an AP to the station on the downlink, the BA acknowledgment information is maintained by the station and sent from the station to the AP. As a result, the AP or the network device (e.g., the UMLD MAC) cannot update the acknowledgment information. In some implementations, the network device may determine that a number of frames retransmitted on a downlink from an original AP to the station meets a predetermined condition. Then, the network device may select another AP (also referred to as virtual AP) to assist the original AP in transmitting a frame to the original AP, where the virtual AP is selected from the neighbor APs of the original AP based on the network conditions of the neighbor APs. In some implementations, the network device may determine that the virtual AP is an MLD. Furthermore, the network device may determine that the frame is transmitted from the original AP to the station through a first link operating on a first frequency band. Then, the network device may select a second link, between the virtual AP and the station, operating on a second frequency band, to assist the original AP in transmitting the frame to the station, where the first frequency band is different from the second frequency band. By selecting the second link operating on a different frequency band, the network device can avoid congestion on the first frequency band and use available bandwidth more efficiently. This results in reduced interference, better performance, and more stable connections for the station.

In some implementations, the virtual AP may assist the first AP in transmitting the frame to the original AP by transmitting a duplicated frame from the virtual AP to the station. In this way, the original AP and the virtual AP can send the same frame to the station at the same time, thereby increasing the possibility of the station receiving the frame and improving the reliability of network transmission.

In some implementations, the network may determine that performance of a target link from the virtual AP to the station is better than performance of the downlink from the first AP to the station. Then, the network may cause the virtual AP to transmit the frame to the station on the target link instead of the first AP. In this way, the link used to transmit the frame can be switched dynamically between these links based on their performance. This ensures the continuous and reliable downlink transmission to the station MLD.

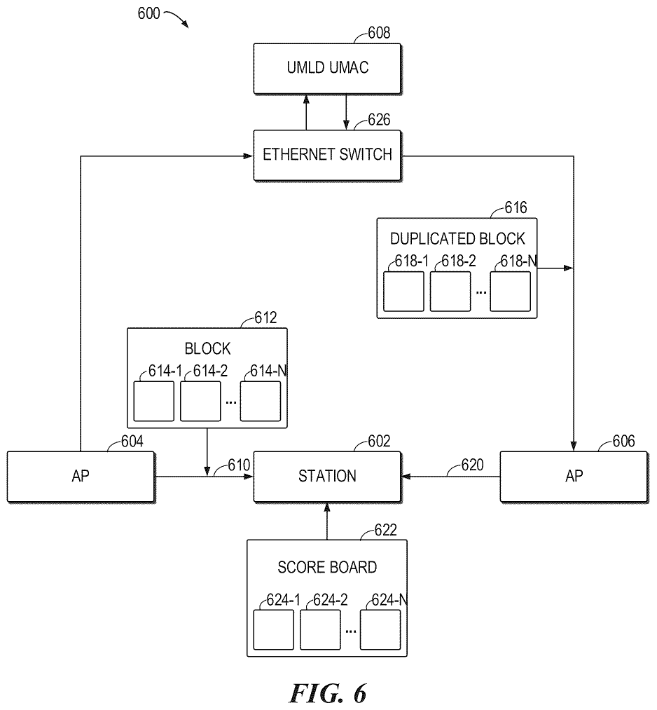

FIG. 6 shows a schematic diagram illustrating an example 600 of transmitting frames from an AP to a station through a downlink according to the implementations of the present disclosure. As shown in FIG. 6, the example 600 includes a station 602, an AP 604, an AP 606, a UMLD UMAC, and an Ethernet switch 626. In the example 600, the station 602, the AP 604, and the AP 606 may be MLDs. The AP 604, the AP 606, and the UMLD UMAC 608 may be connected through the Ethernet switch 626 to communicate over Ethernet.

In the example 600, the AP 604 may transmit a block of frames to the station 602 through the downlink 610. The station 602 may acknowledge the block of frames using a single BA frame. The UMLD UMAC 608 may determine that there is a transmission issue on the downlink 610. For example, the UMLD UMAC 608 may determine that there is a transmission issue by determining that the number of frames retransmitted on the downlink 610 meets a predetermined condition (e.g., the number of frames retransmitted is greater than a predetermined threshold).

After detecting the transmission issue on the downlink 610, the UMLD UMAC 608 may select the AP 606 from the neighbor APs of the AP 604 to assist the AP 604 in transmitting frames to the station 602. In the example 600, the downlink 610 may operate on a first frequency band (e.g., 2.4 GHz). The UMLD UMAC 608 may select a downlink 620, between the AP 606 and the station 602, operating at another frequency band (e.g., 5 GHz) to assist the AP 604 in transmitting frames.

In the example 600, after the AP 606 is configured to assist the AP 604 in transmission frames to the station 602, the AP 604 may transmit a block 612 to the station 602. The block 612 may include frames 614-1, 614-2, . . . , and 614-N (also collectively referred to as frames 614). In addition, the UMLD UMAC 608 may generate a duplicated block 616 corresponding to the block 612, and transmit the duplicated block 616 to the AP 606 over Ethernet. The duplicated block 616 may include duplicated frames 618-1, 618-2, . . . , and 618-N (also collectively referred to as duplicated frames 618), where the duplicated frame 618-1 corresponds to the frame 614-1, the duplicated frame 618-2 corresponds to the frame 614-2, . . . , and the duplicated frame 618-N corresponds to the frame 614-N. Then, the AP 606 may transmit the duplicated block 616 to the station 602.

The station 602 may maintain a score board 622 for the block 612. The score board 622 may include reception statuses 624-1, 624-2, . . . , and 624-N (also collectively referred to as reception statuses 624) for the frames 614. The reception statuses 624 may indicate whether the frames 614 are received or missing. If either the frame 614-1 or the duplicated frame 618-1 is received by the station 602, the reception status 624-1 may be updated to ‘received’.

In the example 600, the station 602 may transmit the score board 622 to the AP 604 in a BA frame. As a result, even if the station 602 fails to receive the frame 614-1 from the AP 604, the frame 614-1 can still be acknowledged because the station 602 has received the duplicated frame 618-1 from the AP 606. In this way, the number of retransmitted frames from the AP 604 to the station 602 can be reduced, and the stability of the network can be improved.

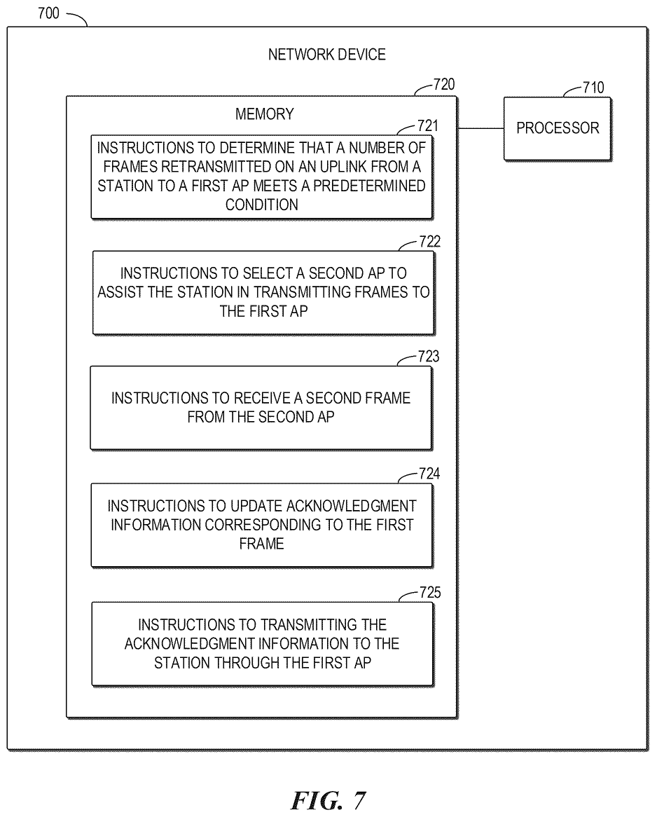

FIG. 7 shows a diagram illustrating an example network device 700 according to the implementations of the present disclosure. As shown in FIG. 7, the network device 700 comprises at least one processor 710, and a memory 720 coupled to the at least one processor 710. The memory 720 stores instructions 721, 722, 723, and 724 to cause the processor 710 to perform actions according to example implementations of the present disclosure.

As shown in FIG. 7, the memory 720 stores the instructions 721 to determine that a number of frames retransmitted on an uplink from a station to a first AP meets a predetermined condition, where the station and the first AP are MLDs. The memory 720 further stores the instructions 722 to select a second AP to assist the station in transmitting frames to the first AP, where the second AP is selected from neighbor APs of the first AP based on network conditions of the neighbor APs, and the neighbor APs are able to receive data transmitted by the station. The memory 720 further stores the instructions 723 to receive a second frame from the second AP, where the second frame is a duplicated frame of a first frame, and the first frame is transmitted by the station to the first AP through a block. The memory 720 further stores the instructions 724 to update acknowledgement information corresponding to the first frame, where the acknowledgement information indicates received frames and missing frames in the block. The memory 720 further stores the instructions 725 to transmit the acknowledgement information to the station through the first AP.

The stored instructions and the functions that the instructions may perform can be understood with reference to implementations as described above. For brevity, the details of instructions 721, 722, 723, 724, and 725 will not be discussed herein.

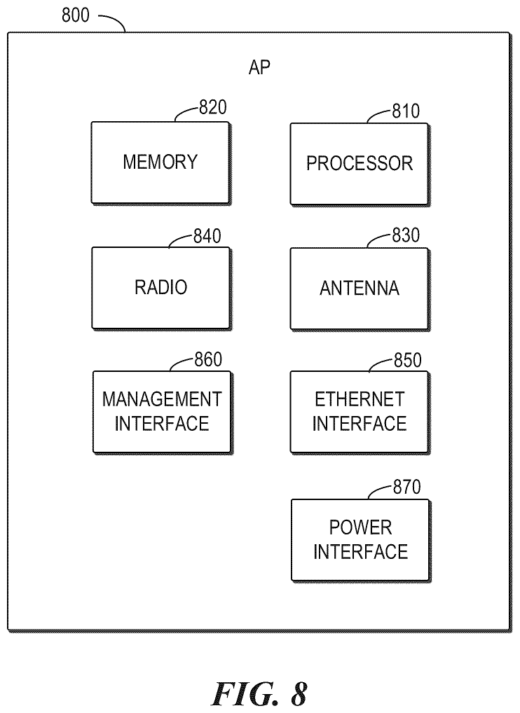

FIG. 8 shows a diagram illustrating an example AP 800 according to the implementations of the present disclosure. As shown in FIG. 8, the AP 800 comprises at least one processor 810, a memory 820 coupled to the at least one processor 810, at least one antenna 830, at least one radio 840, an Ethernet interface 850, a management interface 860 and a power interface 870. The memory 820 stores instructions to cause the processor 810 to perform actions according to example implementations of the present disclosure.

The at least one antenna 830 in the AP 800 is a crucial component that allows the AP 800 to communicate with wireless devices such as laptops, smartphones, and tablets. The primary function of the at least one antenna 830 may be to transmit and receive wireless signals, converting electrical signals into radio waves for outgoing communication and vice versa for incoming signals.

The at least one radio 840 in the AP 800 is responsible for wireless communication. The at least one radio 840 may handle the conversion of data between wired and wireless forms, making it possible for the AP 800 to transmit and receive data over the air. In a modulation process, the digital data from the wired network may be converted into radio waves for wireless transmission. In a demodulation process, incoming radio waves may be converted back into digital data that the AP 800 can process. The at least one radio 840 may operate on specific frequency bands, such as 2.4 GHz, 5 GHz, or 6 GHz bands. The at least one radio 840 may ensure effective communication by selecting appropriate channels to minimize interference. The performance of the at least one radio 840 may be defined by various Wi-Fi standards, including 802.11a/b/g/n/ac/ax, with newer standards like Wi-Fi 6 and Wi-Fi 7 offering improved speed, efficiency, and capacity.

The Ethernet interface 850 in the AP 800 may be used for connecting the AP 800 to the local network, providing a bridge between the wired and wireless segments of the network. The AP 800 may connect to routers, switches, or directly to the internet through the Ethernet interface 850, enabling the wireless devices to communicate with other network resources and the broader internet. The Ethernet interface may support various speeds, including Fast Ethernet (e.g., 100 Mbps), Gigabit Ethernet (e.g., 1 Gbps), and even Multi-Gigabit Ethernet.

The management interface 860 in the AP 800 may allow network administrators to configure, monitor, and manage the settings and performance of the AP 800. The management interface 860 may be accessed through various methods, such as a web browser, command line interface (CLI), or network management protocols like Simple Network Management Protocol (SNMP). Through the management interface 860, the administrators can set up and modify SSIDs, security protocols, VLANs, and other operational parameters, ensuring the AP 800 operates effectively within the network environment.

The power interface 870 in the AP 800 may supply the necessary electrical power to the device, ensuring that the AP 800 may operate smoothly and effectively. This can be achieved through a direct power supply using an AC adapter connected to a power outlet, or via Power over Ethernet (PoE), which delivers power through the same Ethernet cable used for data transmission.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
determining that a number of frames retransmitted on an uplink from a station to a first access point (AP) meets a predetermined condition, wherein the station and the first AP are multi-link devices (MLDs);
selecting a second AP to assist the station in transmitting frames to the first AP, wherein the second AP is selected from neighbor APs of the first AP based on network conditions of the neighbor APs, and the neighbor APs are able to receive data transmitted by the station;
receiving a second frame from the second AP, wherein the second frame is a duplicated frame of a first frame, and the first frame is transmitted by the station to the first AP through a block;
updating acknowledgment information corresponding to the first frame, wherein the acknowledgment information indicates received frames and missing frames in the block; and
transmitting the acknowledgment information to the station through the first AP.

2. The method according to claim 1, wherein determining that the number of the frames retransmitted on the uplink from the station to the first AP meets the predetermined condition comprises:
determining that the number of the frames retransmitted on the uplink from the station to the first AP is greater than a predetermined retransmission threshold.

3. The method according to claim 1, wherein determining that the number of the frames retransmitted on the uplink from the station to the first AP meets the predetermined condition comprises:
receiving, from the first AP, a request for a link of an additional AP to assist in transmitting frames from the station to the first AP.

4. The method according to claim 1, wherein determining that the number of the frames retransmitted on the uplink from the station to the first AP meets the predetermined condition comprises:
enabling an extreme high throughput (EHT) feature; and
determining that the number of the frames retransmitted on the uplink from the station to the first AP meets the predetermined condition.

5. The method according to claim 1, wherein the neighbor APs comprise the second AP and a third AP, and selecting the second AP to assist the station in transmitting the frames to the first AP comprises:
determining that the second AP is an MLD;
determining that the third AP is a non-MLD; and
selecting the second AP to assist the station in transmitting the frames to the first AP.

6. The method according to claim 1, wherein the neighbor APs comprise the second AP and a third AP, and selecting the second AP to assist the station in transmitting the frames to the first AP comprises:
determining that the second AP and the third AP are MLDs;
determining that a number of links of the second AP is greater than a number of links of the third AP; and
selecting the second AP to assist the station in transmitting the frames to the first AP.

7. The method according to claim 1, wherein selecting the second AP to assist the station in transmitting the frames to the first AP comprises:
determining a load of the second AP; and
determining that the load of the second AP is less than a predetermined load threshold; and
selecting the second AP to assist the station in transmitting the frames to the first AP.

8. The method according to claim 1, wherein selecting the second AP to assist the station in transmitting the frames to the first AP comprises:
determining a first score indicating performance of the first AP based on a channel utility and a client number of the first AP;
determining a second score indicating performance of the second AP based on a channel utility and a client number of the second AP; and
determining that the second score is greater than the first score; and
selecting the second AP to assist the station in transmitting the frames to the first AP.

9. The method according to claim 1, wherein the first frame is captured by the second AP based on a destination of the first frame being the first AP.

10. The method according to claim 1, wherein the first frame is captured by the second AP based on information contained in the first frame, and the information comprises at least one of a transmission identifier (TID), a media access control (MAC) address, or a frame type.

11. The method according to claim 1, wherein the predetermined condition is a first predetermined condition, and the method further comprises:
determining that a number of frames retransmitted on a downlink from the first AP to the station meets a second predetermined condition; and
selecting a fourth AP to assist the first AP in transmitting a third frame to the first AP, wherein the fourth AP is selected from the neighbor APs of the first AP based on the network conditions of the neighbor APs.

12. The method according to claim 11, wherein selecting the fourth AP to assist the first AP in transmitting the third frame to the first AP comprises:
determining that the fourth AP is an MLD;
determining that the third frame is transmitted from the first AP to the station through a first link operating on a first frequency band; and
selecting a second link, between the fourth AP and the station, operating on a second frequency band, to assist the first AP in transmitting the third frame to the station, wherein the first frequency band is different from the second frequency band.

13. The method according to claim 11, wherein the fourth AP assists the first AP in transmitting the third frame to the first AP by transmitting a duplicated frame of the third frame from the fourth AP to the station.

14. The method according to claim 11, further comprising:
determining that performance of a target link from the fourth AP to the station is better than performance of the downlink from the first AP to the station; and
causing the fourth AP to transmit the third frame to the station on the target link instead of the first AP.

15. A network device comprising:
at least one processor; and
a memory coupled to the at least one processor, the memory storing instructions to cause the at least one processor to:
determine that a number of frames retransmitted on an uplink from a station to a first access point (AP) meets a predetermined condition, wherein the station and the first AP are multi-link devices (MLDs);
select a second AP to assist the station in transmitting frames to the first AP, wherein the second AP is selected from neighbor APs of the first AP based on network conditions of the neighbor APs, and the neighbor APs are able to receive data transmitted by the station;
receive a second frame from the second AP, wherein the second frame is a duplicated frame of a first frame, and the first frame is transmitted by the station to the first AP through a block;
update acknowledgment information corresponding to the first frame, wherein the acknowledgement information indicates received frames and missing frames in the block; and
transmit the acknowledgment information to the station through the first AP.

16. The network device according to claim 15, wherein the instructions causing the at least one processor to determine that the number of the frames retransmitted on the uplink from the station to the first AP meets the predetermined condition comprise instructions causing the at least one processor to:
determine that the number of the frames retransmitted on the uplink from the station to the first AP is greater than a predetermined retransmission threshold.

17. The network device according to claim 15, wherein the instructions causing the at least one processor to determine that the number of the frames retransmitted on the uplink from the station to the first AP meets the predetermined condition comprise instructions causing the at least one processor to:
receive, from the first AP, a request for a link of an additional AP to assist in transmitting frames from the station to the first AP.

18. The network device according to claim 15, wherein the instructions causing the at least one processor to determine that the number of the frames retransmitted on the uplink from the station to the first AP meets the predetermined condition comprise instructions causing the at least one processor to:
enable an extremely high throughput (EHT) feature; and
determine that the number of the frames retransmitted on the uplink from the station to the first AP meets the predetermined condition.

19. The network device according to claim 15, wherein the neighbor APs comprise the second AP and a third AP, and the instructions causing the at least one processor to select the second AP to assist the station in transmitting the frames to the first AP comprise instructions causing the at least one processor to:
determine that the second AP is an MLD;
determine that the third AP is a non-MLD; and
select the second AP to assist the station in transmitting the frames to the first AP.

20. A non-transitory computer-readable medium comprising instructions stored thereon which, when executed by a network device, cause the network device to:
determine that a number of frames retransmitted on an uplink from a station to a first access point (AP) meets a predetermined condition, wherein the station and the first AP are multi-link devices (MLDs);
select a second AP to assist the station in transmitting frames to the first AP, wherein the second AP is selected from neighbor APs of the first AP based on network conditions of the neighbor APs, and the neighbor APs are able to receive data transmitted by the station;
receive a second frame from the second AP, wherein the second frame is a duplicated frame of a first frame, and the first frame is transmitted by the station to the first AP through a block;
update acknowledgment information corresponding to the first frame, wherein the acknowledgment information indicates received frames and missing frames in the block; and
transmit the acknowledgment information to the station through the first AP.
